(19) United States
(12) Patent Application Publication
(10) Pub. No.: US 2012/0268887 A1
(43) Pub. Date: Oct. 25, 2012

(54) FLASH DRIVE

(75) Inventors: JIAN-CHUN PAN, Shenzhen City (CN); HAI-QING ZHOU, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/097,103

(22) Filed: Apr. 29, 2011

(30) Foreign Application Priority Data
Apr. 21, 2011 (CN) 201110100890.X

(51) Int. Cl. G06F 1/16

(52) U.S. Cl. 361/679.32

(57) ABSTRACT

A flash drive includes a main body and a casing pivotably installed to a first end of the main body. A universal serial bus (USB) connector extends from a second end of the main body. The casing includes two plates and an end piece perpendicularly connected between ends of the plates. The casing is pivoted toward the USB connector to enclose the USB connector.

### BACKGROUND

1. Technical Field

The present disclosure relates to a universal serial bus (USB) flash drive.

2. Description of Related Art

A casing for protecting a USB connector of a flash drive generally is separable from the flash drive. As a result, the casing may be lost easily.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a flash drive; the flash drive includes a main body and two casings.

FIG. 2 is an assembled, isometric view of FIG. 1.

FIG. 3 is similar to FIG. 2, but showing the main body received in the casings completely.

FIG. 4 is an assembled, isometric view of another flash drive; the flash drive includes the main body of FIG. 1 and a single casing.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

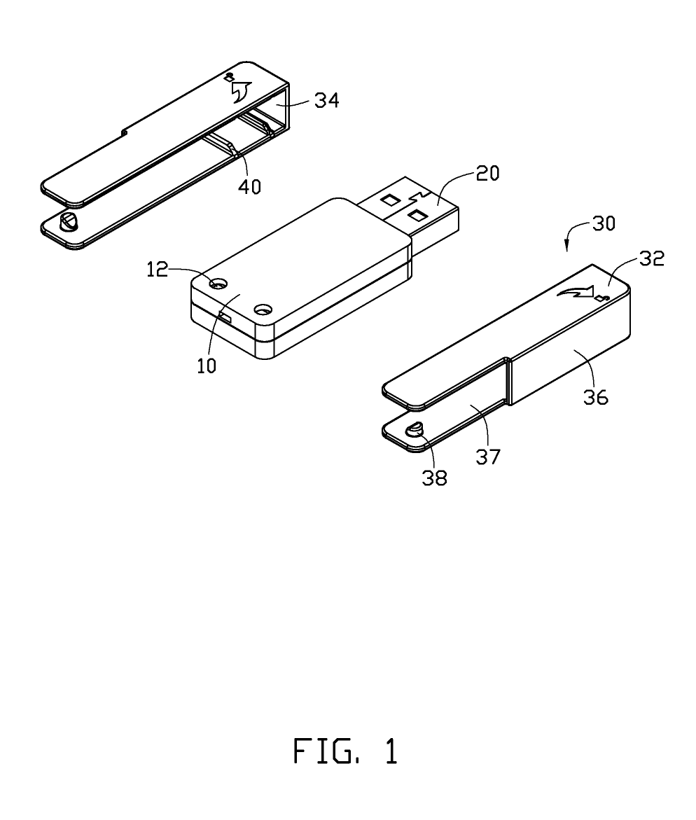

Referring to FIG. 1, an exemplary embodiment of a flash drive includes a main body 10 and two casings 30.

A universal serial bus (USB) connector 20 is formed on a first end of the main body 10. Top and bottom surfaces of a second end (opposite to the first end) of the main body 10 each define two fixing holes 12 therein.

Each casing 30 includes two plates 32 parallel to each other, an end piece 34 perpendicularly connected between first ends of the plates 32, and a side piece 36 perpendicularly connected between first sides of the plates 32 adjacent to the first ends of the plates 32. A cutout 37 is defined between the first sides of the plates 32, adjacent to second ends of the plates 32. Two blocking pieces 40 protrude from an inner surface of each plate 32, adjacent to the first end of the plate 32. A protrusion 38 protrudes from the inner surface of each plate 32, adjacent to the second end of the plate 32.

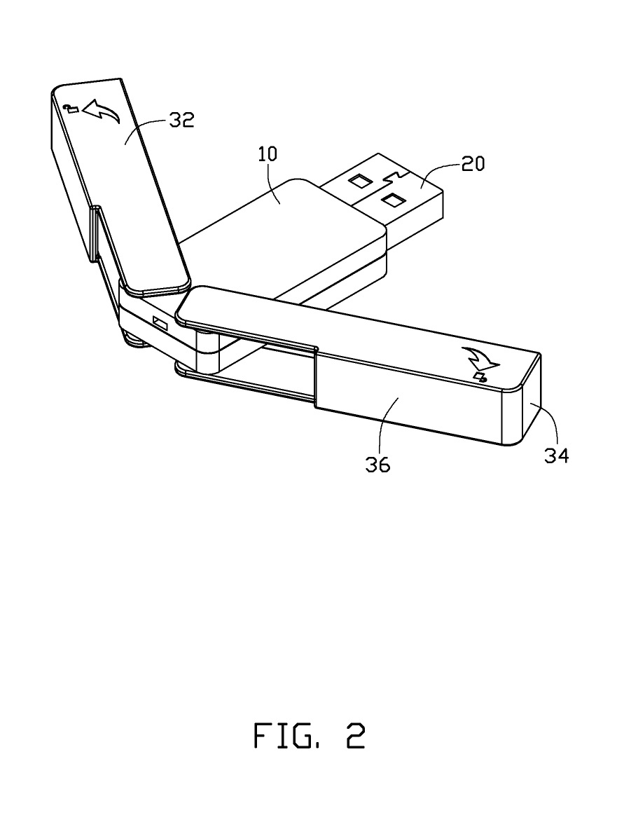

Referring to FIG. 2, in assembly, the second ends of the plates 32 of each casing 30 are deformed away from each other, the second end of the main body 10 is placed between the second ends of the plates 32. The protrusions 38 of the plates 32 are engaged in the corresponding fixing holes 12, to pivotably mount the casing 30 to the main body 10.

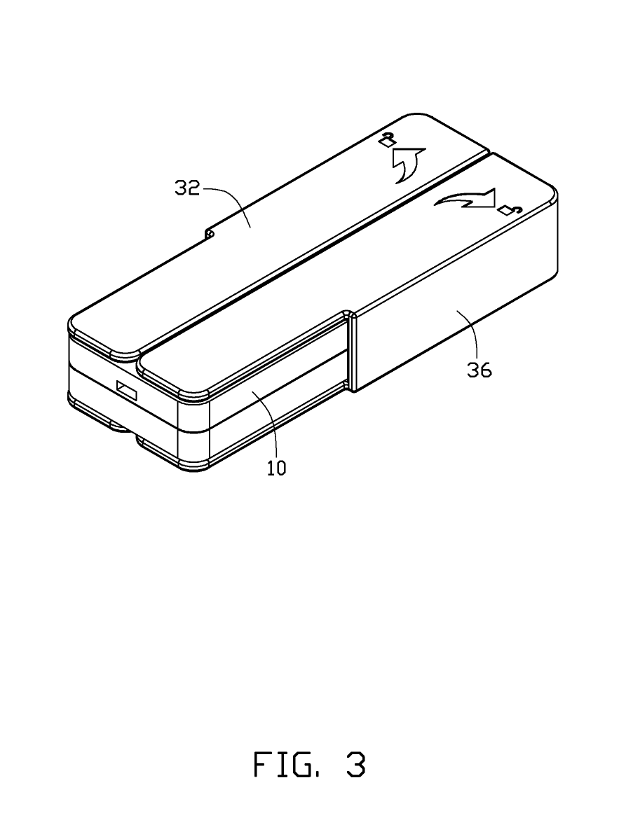

Referring to FIG. 3, in use, the casings 30 are pivoted toward the USB connector 20 to contact with each other. The main body 10 and the USB connector 20 are enclosed by the casings 30. The end pieces 34 cover a distal end of the USB connector 20. Thereby, the main body 10 and the USB connector 20 are completely received in the casings 30. The USB connector 20 is sandwiched between the blocking pieces 40 of the plates 32.

In using the USB connector 20, the casings 30 are pivoted away from each other to expose the USB connector 20.

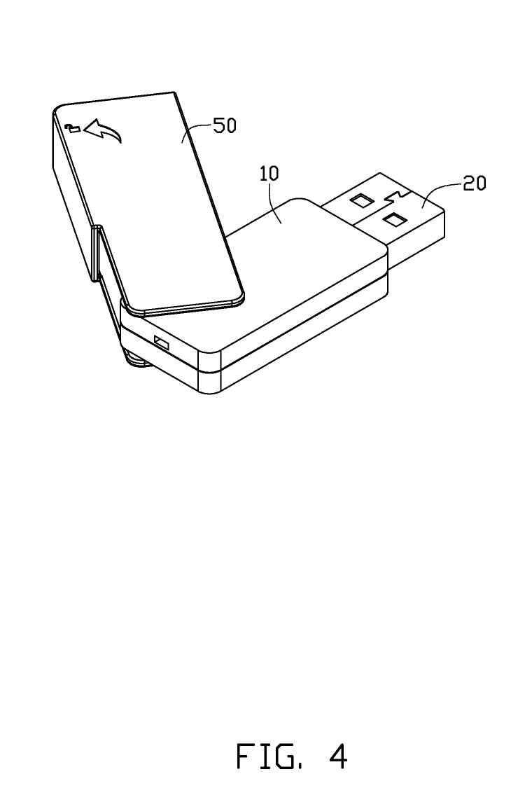

Referring to FIG. 4, in another embodiment, the main body 10 may have with a single casing 50 only. The casing 50 is made wide enough to completely encompass the USB connector 20, and the USB connector 20 can be pivoted out from one side of the casing 50.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A flash drive, comprising:
a main body;
a universal serial bus (USB) connector extending from a first end of the main body; and
a casing comprising two plates and an end piece perpendicularly connected between first ends of the plates, wherein second ends of the plates are pivotably installed to a second end of the main body, the plates are operable to pivot toward the USB connector to enclose the USB connector.

2. The flash drive of claim 1, wherein two fixing holes are defined in each of top and bottom surfaces of the main body, a protrusion extends from an inner surface of the second end of each plate for engaging in a corresponding fixing hole of the main body.

3. The flash drive of claim 2, wherein a blocking piece protrudes from the inner surface of each plate, adjacent to the first end, the USB connector is sandwiched between the blocking pieces of the plates.

4. The flash drive of claim 3, wherein a side piece perpendicularly connected between corresponding sides of the plates, adjacent to the first end.

5. A universal serial bus (USB) flash drive, comprising:
a main body;
a USB connector extending from a first end of the main body; and
two casings each comprising two plates and an end piece perpendicularly connected between first ends of the plates, wherein second ends of the plates sandwich a second end of the main body and are pivotably installed to the second end of the main body, the casings are operable to pivot toward each other to enclose the main body and the USB connector.

6. The USB flash drive of claim 5, wherein two fixing holes are defined in each of top and bottom surfaces of the main body, a protrusion extends from an inner surface of the second end of each plate for engaging in a corresponding fixing hole of the main body.

7. The USB flash drive of claim 6, wherein a blocking piece protrudes from the inner surface of each plate, adjacent to the first end, the USB connector is sandwiched between the blocking pieces of the plates.

8. The USB flash drive of claim 7, wherein a side piece perpendicularly connected between corresponding sides of the plates, adjacent to the first end, to enclose a corresponding side of the main body and a corresponding side of the USB connector.
